(19) United States
(12) Patent Application Publication
(10) Pub. No.: US 2011/0075603 A1
(43) Pub. Date: Mar. 31, 2011

(54) MEDIUM ALLOCATION IN A DISTRIBUTED NETWORK

(76) Inventor: ALAA MUQATTASH, San Diego, CA (US)

(21) Appl. No.: 12/571,235

(22) Filed: Sep. 30, 2009

(51) Int. Cl. H04W 40/00

(52) U.S. Cl. 370/328

(57) ABSTRACT

A method of network operations comprises conducting communication activities at a first network device using a shared network medium and having a first coverage area, wherein the communication activities comprise broadcasting a data transmission reservation or receiving a data transmission reservation of another network device during a beacon period; and conducting communications with the first network device at a second network device using the shared network medium; wherein the second network device is configured to provide a second coverage area that is substantially contained within the first coverage area and wherein the second network device does not monitor network communications during the beacon period.

### TECHNICAL FIELD

The present invention relates generally to communication networks, and more particularly, some embodiments relate to medium access in distributed networks.

### DESCRIPTION OF THE RELATED ART

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. Examples of communication networks that are gaining widespread popularity include exemplary implementations of wireless networks such as the Bluetooth®, Wireless USB, and various IEEE standards-based networks such as 802.11 and 802.16 communications networks, to name a few.

Architects of these and other networks, and indeed communications channels in general, have long struggled with the challenge of managing multiple communications among many devices across a band-limited channel. For example, in some environments, more than one device may share a common carrier channel and thus the devices run the risk of encountering a communication conflict among the one or more other devices on the channel.

Over the years, network architects have come up with various solutions to arbitrate disputes or otherwise delegate bandwidth among the various communicating devices, or clients, on the network. Schemes used in well known network configurations such as token rings, Ethernet, and other configurations have been developed to allow sharing of the available bandwidth.

Peer networks, such as MB-OFDM ultrawideband networking systems for example, often take advantage of a beacon period to attend to media access slot reservations. In these systems, communication activities are conducted using superframes. A superframe generally comprises a group of timeslots, wherein a first portion of the timeslots comprises a beaconing period and a second portion of the timeslots comprises a data transfer period. In these systems, the beaconing period is divided into a plurality of beacon slots, which are reserved by network elements and used for functions such as synchronization and reservation of upcoming medium access slots. The data transfer period is divided into a plurality of medium access slots that are used for actual data transmission.

Typically, protocols are established that allow the beaconing period to be extended when more devices than the current beacon period can handle attempt to connect to the network. However, each such extension reduces the number of available medium access slots. Furthermore, all devices in such networks are typically required to participate in beaconing. Even in systems where devices, such as low power or hibernating devices, are not required to transmit during the beacon period, these device are still required to monitor the beacon period. For example, even hibernating devices will sometimes wake up to monitor the beacon period. This beacon reception, transmission, and processing may result in significant power consumption and require considerable chip resources.

### BRIEF SUMMARY OF EMBODIMENTS OF THE INVENTION

According to various embodiments of the invention, systems and methods are provided for allowing non-beaconing network devices to coexist in networks with beaconing network devices. In some embodiments, a first group of devices that transmit at higher power or have a greater coverage range communicate with each other using a communications protocol implementing beacon periods, while a second group of devices that transmit at lower powers or have a smaller coverage range communicate with members of the first group without utilizing beacon periods. In these embodiments, the coverage ranges of the second group of devices may be configured so that they do not interfere with the remaining elements of the first group.

According to an embodiment of the invention, a method of network operations comprises conducting communication activities at a first network device using a shared network medium and having a first coverage area, wherein the communication activities comprise broadcasting a data transmission reservation or receiving a data transmission reservation of another network device during a beacon period; and conducting communications with the first network device at a second network device using the shared network medium; wherein the second network device is configured to provide a second coverage area that is substantially contained within the first coverage area and wherein the second network device does not monitor network communications during the beacon period.

According to another embodiment of the invention, a plurality of beaconing devices may establish a network where communications between the beaconing devices are scheduled during beaconing periods. A non-beaconing network device operates in a non-beaconing mode, where it does not receive, process, or transmit beacons during a beaconing period. This non-beaconing network device is configured to connect to one of the beaconing network devices and is further configured such that any other beaconing device that the non-beaconing device might interfere with is within the range of the connected beaconing network device. For example, the non-beaconing device may be configured to have a smaller maximum coverage range than that of the beaconing network devices, or the non-beaconing device may be configured to reconfigure its coverage area, for example by using directional antennae, to reduce interference with the non-connected beaconing devices.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example environment in which embodiments of the invention may be implemented.

FIG. 2A illustrates a superframe that may be used during communication activities in some embodiments of the invention.

FIG. 2B is a diagram illustrating an example generalized configuration of a network device with which the techniques described herein can be implemented.

FIG. 3 illustrates an example implementation of an embodiment of the invention.

FIG. 4 illustrates an example of coverage areas in accordance with some embodiments of the invention.

FIG. 5 illustrates another example of coverage areas in accordance with some embodiments of the invention.

FIG. 6 illustrates an example of interaction between beaconing and non-beaconing devices according to an embodiment of the invention.

FIG. 7 illustrates an example network including beaconing and non-beaconing devices according to an embodiment of the invention.

FIG. 8 illustrates a non-beaconing device having a coverage area encompassed by a coverage area of a beaconing device according to an embodiment of the invention.

FIG. 9 illustrates a hybrid network architecture according to an embodiment of the invention.

FIG. 10 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed towards systems and methods for allowing non-beaconing network devices to coexist in networks with beaconing network devices. In some embodiments, a first group of devices that transmit at higher power or have a greater coverage range communicate with each other using a communications protocol implementing beacon periods, while a second group of devices that transmit at lower powers or have a smaller coverage range communicate with members of the first group without utilizing beacon periods. In these embodiments, the coverage ranges of the second group of devices may be configured so that they do not interfere with the remaining elements of the first group.

Before describing the invention in detail, it is useful to describe an example environment in which the invention can be implemented. One such example is a wireless beaconing network in which multiple electronic devices (for example, computers and computing devices, cellular telephones, personal digital assistants, motion and still cameras, among others) can communicate and share data, content and other information with one another. One example of such a network is that as specified by the WiMedia standard (WiMedia transferred specification development of its version of ultrawideband (UWB) to the Bluetooth® Special Interest Group, the Wireless USB Promoter Group and the USB Implementers Forum) or other networks utilizing a beacon period or similar medium access reservation period.

Most network standards specify policies or rules that govern the behavior of network connected devices. For example, a standard can specify the mechanism and policies that are to be followed by W-USB compliant devices in order to allow for an ad hoc and distributed network of such devices to operate efficiently. In most distributed networks, the network of the devices is maintained by requiring all devices to announce parameters such as their presence, their capabilities and their intentions for reserving transmission slots and so on. For example, this can be done during what are referred to as beacon period time slots. According to such a network, devices joining the network are expected to monitor the beacon period to learn about the network status and parameters before attempting to use the network. In other network configurations, beacon periods are similarly used to allow management of network devices as described more fully below. Thus, beacon periods are one form of window or network period during which scheduling or other housekeeping activities can be conducted. Beacon periods in the above-referenced standard, and other time periods used for scheduling or other housekeeping chores in other network configurations, are generally referred to as beacon periods or scheduling windows.

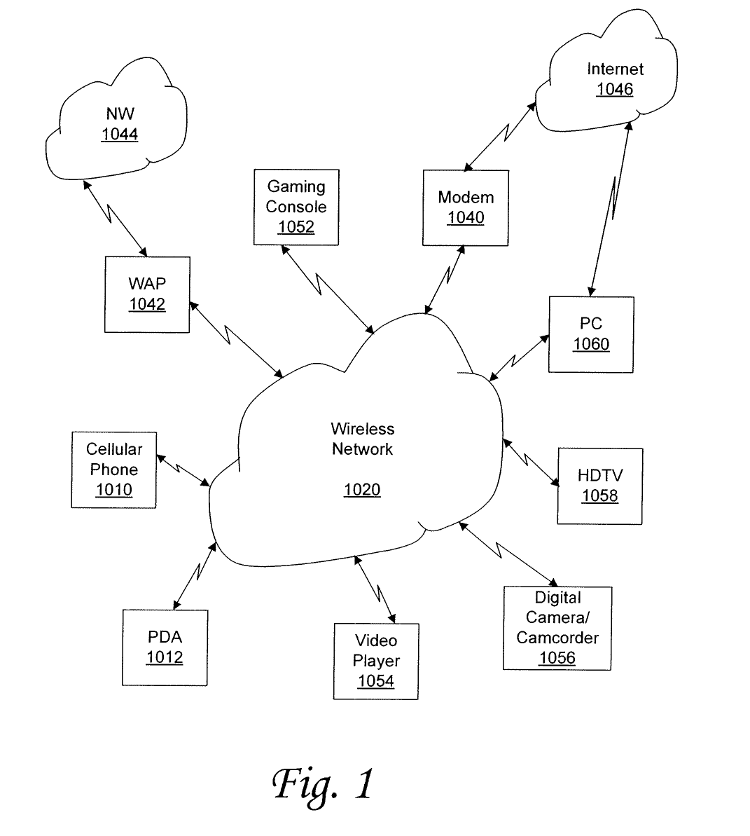

FIG. 1 is a block diagram illustrating one possible configuration of a wireless network that can serve as an example environment in which the present invention can be implemented. Referring now to FIG. 1, a wireless network 1020 is provided to allow a plurality of electronic devices to communicate with one another without the need for wires or cables between the devices. A wireless network 1020 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 1020 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 1020 includes a communication device to allow it to communicate with external networks. More particularly, in the illustrated example, wireless network 1020 includes a modem 1040 to provide connectivity to an external network such as the Internet 1046, and a wireless access point 1042 that can provide external connectivity to another network 1044.

Also illustrated in the example wireless network 1020 are portable electronic devices such as a cellular telephone 1010 and a personal digital assistant (PDA) 1012. Like the other electronic devices illustrated in FIG. 1, cellular telephone 1010 and PDA 1012 can communicate with wireless network 1020 via the appropriate wireless interface. Additionally, these devices may be configured to further communicate with an external network. For example, cellular telephone 1010 is typically configured to communicate with a wide area wireless network by way of a base station.

Additionally, the example environment illustrated in FIG. 1 also includes examples of home entertainment devices connected to wireless network 1020. In the illustrated example, electronic devices such as a gaming console 1052, a video player 1054, a digital camera/camcorder 1056, and a high definition television 1058 are illustrated as being interconnected via wireless network 1020. For example, a digital camera or camcorder 1056 can be utilized by a user to capture one or more still picture or motion video images. The captured images can be stored in a local memory or storage device associated with digital camera or camcorder 1056 and ultimately communicated to another electronic device via wireless network 1020. For example, the user may wish to provide a digital video stream to a high definition television set 1058 associated with wireless network 1020. As another example, the user may wish to upload one or more images from digital camera 1056 to his or her personal computer 1060 or to the Internet 1046. This can be accomplished by wireless network 1020. Of course, wireless network 1020 can be utilized to provide data, content, and other information sharing on a peer-to-peer or other basis, as the provided examples serve to illustrate.

Also illustrated is a personal computer 1060 or other computing device connected to wireless network 1020 via a wireless air interface. As depicted in the illustrated example, personal computer 1060 can also provide connectivity to an external network such as the Internet 1046.

In the illustrated example, wireless network 1020 is implemented so as to provide wireless connectivity to the various electronic devices associated therewith. Wireless network 1020 allows these devices to share data, content, and other information with one another across wireless network 1020. Typically, in such an environment, the electronic devices would have the appropriate transmitter, receiver, or transceiver to allow communication via the air interface with other devices associated with wireless network 1020. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 1020 are sometimes referred to herein as network devices, members or member devices of the network or devices associated with the network. In one embodiment devices that communicate with a given network may be members or merely in communication with the network.

Some communication networks are divided into periods or frames that can be used for communication and other activities. For example, as discussed above, some networks have a scheduling window such as, for example, a beacon period, for scheduling upcoming communication activities. Also, some networks have a communication window during which such communication activities take place. In some networks, the bandwidth is divided into superframes, which in turn are divided into time slots for the transmission and reception of data by the various electronic devices associated with the network.

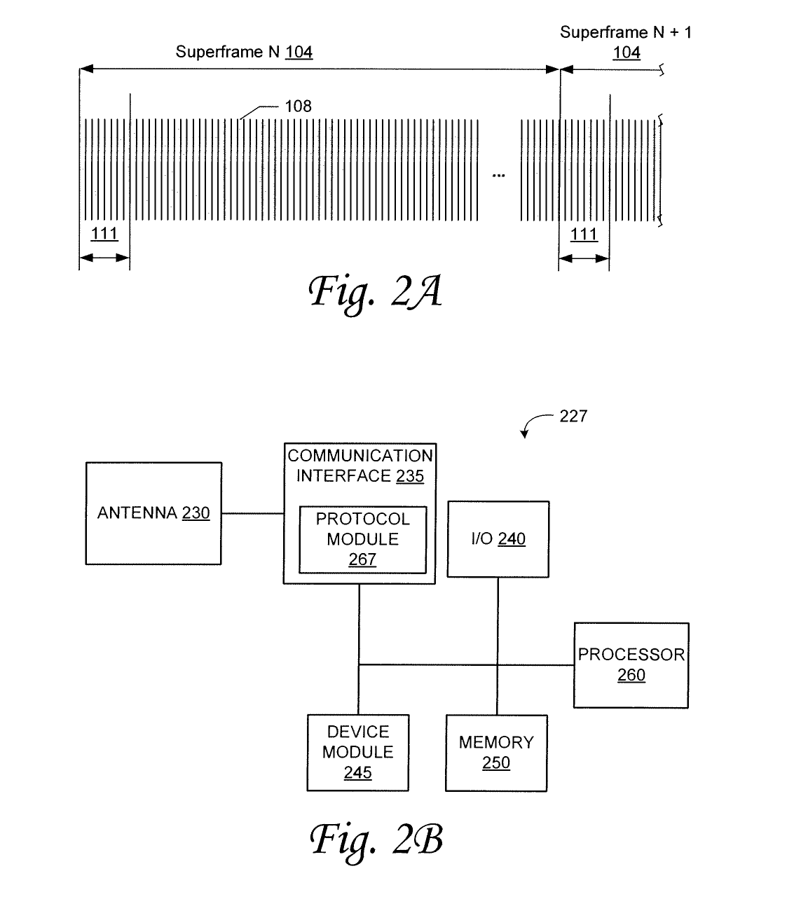

An example of such time slots are illustrated in FIG. 2A. Referring now to FIG. 2A, in this exemplary environment, the communication bandwidth is divided into superframes 104 (two illustrated), each superframe 104 itself being divided into a plurality of timeslots referred to as media access slots 108. In the example environment, there are 256 media access slots 108 in each superframe 104, although other allocations are possible. Additionally, at the beginning of each superframe 104 is a beacon period 111, which is comprised of a plurality of beaconing slots. In some networks, the beacon period 111 is a period during which devices reserve timeslots for communication in the superframe 104 and exchange other housekeeping or status information. For example, in the WiMedia-MBOA distributed wireless network, the superframes comprise a beacon period 111, during which devices are awake and receive beacons from other devices. Superframes in the above-referenced standard, and other time periods used for communications among devices in other network configurations, with or without scheduling windows, are generally referred to herein as communication windows. As noted above, for clarity of description the present invention is described in terms of the example environment, and thus is at times described using the terms superframe and beacon period. As would be apparent to one of ordinary skill in the art after reading this description, the invention applies to other communication formats, including the more general case utilizing scheduling windows and communication windows. Additionally, the invention is not limited to applications where the bandwidth is divided into frames or windows, but can be generally applied to communication channels and networks of various protocols and configurations.

FIG. 2B is a diagram illustrating an example generalized configuration of a network device with which the techniques described herein can be implemented. The network device 227 in the illustrated example includes an antenna, a communication interface 235; a dedicated device module 245; memory 250; a processor 260; and an input output module 240. Communications interface 235 might be provided, for example, to allow the device 227 to communicate with other network devices such as other peer devices in a peer-to-peer communication network. A communications transceiver, having a transmitter and receiver, is included in this example to allow two-way communications with other devices. In the case of an OFDM compatible device, the transceiver can be used to modulate data to be communicated onto the orthogonal carriers and to receive, downconvert and demodulate data from other devices. A protocol module 267 might also be provided to perform some or all of the beacon slot configuration functions described herein. Such a module might be included as part of the functionality performed by communications interface 235, dedicated device module 245 or processor 260 or other computing module.

A processor 260 and memory 250 can be included to facilitate device functionality. Take, for instance, a digital camera as a network device. This device might include one or more processors 260 and device modules 245 to control device operation, to process images for display and storage, to manage network communications, and so on. Memory of various forms or other storage devices can be included to allow storage of instructions for the processor, computational products, captured images and so on. The example illustrated in FIG. 2B also includes an I/O module 240 to allow other forms of communication.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments with different networks, network topologies and governing standards.

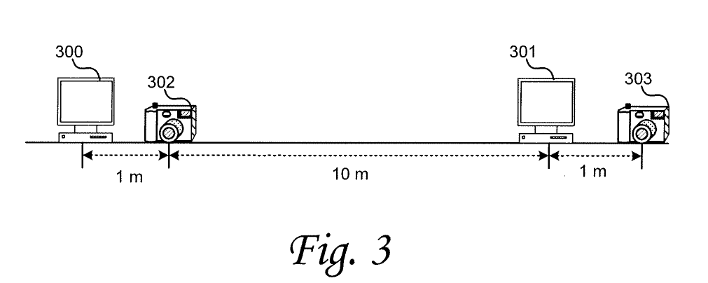

In some environments, the physical layout of the network into the characteristics of the network usage may be such that, although connectivity of the network as a whole is desired, some devices might communicate with the network as a whole, while other devices might communicate only with nearby network devices. FIG. 3 illustrates such example network according to an embodiment of the invention. In this example, two personal computers, PC 300 and PC 301 are in a network where communication activities take place during superframes and the personal computers PC 301 and PC 302 exchange reservations and other housekeeping matters during beacon periods of the superframes. Each beaconing network device is in further communication with a non-beaconing device; PC 300 is in communication with non-beaconing camera 302 and PC 301 is in communication with non-beaconing camera 303. In the illustrated example, these connections take place using the same medium used in the connection between PC 300 and PC 301. The various illustrated network devices may be equipped with different coverage areas and transmit powers and May be situated at different relative location, as illustrated. In the illustrated embodiment, assuming PC 300 and PC 301 transmitted at the same power levels, because of free space propagation over the indicated distances, camera 302 receives a signal from PC 301 that is less than 1% of that received from PC 300. Similarly, PC 301 receives a signal from camera 302 that is less than 1% of that received from camera 303. In various embodiments, these differences mean that, for example, PC 301 is unable to interfere with camera 302's connection to PC 300. Accordingly, in one embodiment, a network device may implement various methods to determine that network devices other than the one with which it is communicating cannot interfere with its communication activities. Such a network device may then be configured to enter a non-beaconing mode where the network device does not monitor the beacon periods of other network devices. This non-beaconing mode may further comprise lowering transmit power levels or taking other steps to mitigate the risk that the non-beaconing device will interfere with other network communications but still remain able to perform its own communications. In some embodiments, network devices may be change locations during existence of the network. For example, a network connected laptop or PDA may change locations during network communications. In this embodiment, because the non-beaconing device is not able to monitor the beacons of such mobile devices, it may be configured to enter a beaconing state at certain pre-determined intervals. For example, this beaconing interval might be pre-programmed or might be obtained from other network devices. Such an embodiment would still maintain some power savings by avoiding the requirement to monitor each superframe's beacon period. In further embodiments, the connected device with which the non-beaconing device is communicating may be configured to alert the non-beaconing device that it needs to leave the non-beaconing mode.

As used herein, the channel gain between network devices A and B is denoted by G_{AB}, the transmission power level of device A is denoted by P_{A}, and the average reception power of device A's signal as received by device B is denoted by P_{AB}, where P_{AB}=P_{A}/G_{AB}. As used herein, the term “coverage area” is the area around a transmitter in which the transmitter's signals can be properly detected and decoded. In some embodiments, the coverage area can be described as there area in which receivers will experience no more than a certain predetermined packet error rate (PER), for example X % PER, assuming only thermal noise (interference free), maximum transmission power, and minimum transmission rate. As used herein, the term “maximum range” refers to the maximum distance from the transmitter within the transmitter's coverage area.

As used herein, “closeness” refers to differences in channel gain. For example, if three network devices A, B, and C are communicating, and G_{AB}<G_{AC} then B is closer to A than C and, vice versa, C is further from A then it is from B. In various environments and implementations, channel gain may generally vary with actual location, and, therefore, close devices will be physically near each other. However, this may not always be the case.

In some figures herein, for ease of explanation, coverage areas are illustrate as circles, where distance from the center of the circle represents channel gain. In actual environments, various characteristics, such as terrain, interference, cancellation, etc., will prevent actual coverage areas from being circular and will prevent actual channel gains from varying directly with distance from the transmitter.

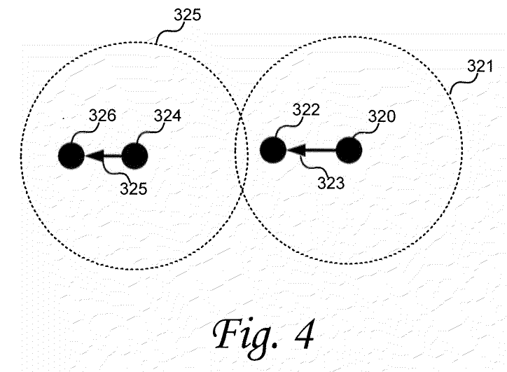

In some embodiments, a pre-existing physical (PHY) layer access protocol (such as the PHY protocol defined by the WiMedia 1.2 specification) may provide methods that manage the interference that may be caused by an out of range device's transmissions. FIG. 4 illustrates such a situation, where medium access protocols are not necessary to manage secondary interference. In this environment, device 322 is outside the maximum range 325 of device 324. Likewise, device 326 is outside the maximum range 321 of device 320. Accordingly, device 324's transmissions will only secondarily interfere with link 323 in a manner that may be accommodated for through coding and error correction performed at the PHY level.

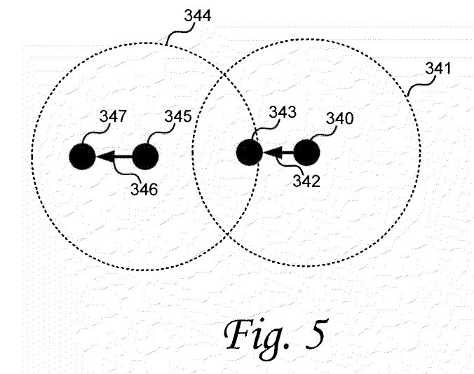

FIG. 5 illustrates another situation where interference may be disregarded in medium access control methods according to an embodiment of the invention. In this example, receiving device 343 is within the maximum range 344 of transmitting device 345, and therefore has the capability to receive frames from device 345. Accordingly, in typical medium access control protocols, receiving device 343 might be required to beacon its intended reception slots to ensure that transmitting device 345 does not also transmit during those slots. However, as discussed herein, device 343 may be close enough to device 340 so that the signal to noise ratio at device 343 for link 342 is such that device 345's transmission will not actually interfere with link 342. Even if devices 345 and 340 are transmitted at the same power levels, the gain between the device 340 and 343 is sufficiently greater than the gain between device 345 and device 343 such that the power received by device 343 from device 340 is sufficiently greater than the power received from device 345 so that interference with link 342 does not occur.

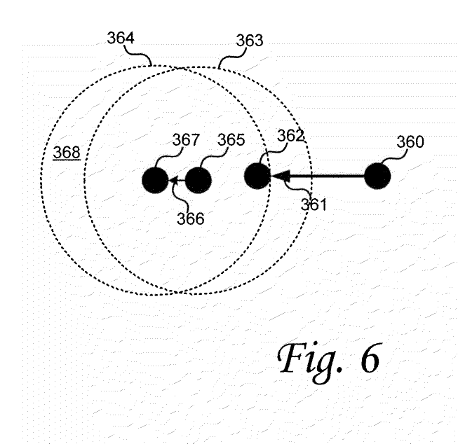

FIG. 6 illustrates another example of interaction between beaconing and non-beaconing devices according to an embodiment of the invention. In this example, four network devices 360, 362, 365, and 367 coexist within a wireless ad hoc network and may comprise a mixture of beginning and non-beaconing devices as described herein. Network device 362 may be engaged in data exchange with network device 360 over link 361 while network devices 367 and 365 are engaged in data exchange over link 366. In the illustration, device 362 is within the maximum range 363 of device 365 and is within the maximum range 364 of device 367. The link distance 361 may also be such that either device 367 and 365 may interfere with frame reception at device 362. In embodiments employing superframes data transmission over link 366 employs a particular scheduled portion of the available data transmission slots and both devices 365 and device 367 are aware of this schedule. Accordingly, link 361 can be protected if either device 365 or device 367 beacons the slot reservations needed for link 366. In this embodiment, it is not necessary for both devices 367 and 365 to beacon their slot reservations. Accordingly, one of the devices, such as device 367, may comprise a non-beaconing device, or a dual-mode device in a non-beaconing mode, that relies on the device it shares its link with to beacon the link reservations. In various environments, unless the beaconing and non-beaconing devices are very close to each other, if the beaconing and non-beaconing devices have similar coverage areas there will be a portion 368 of the non-beaconing device's coverage range that will not be protected by beaconing device's 365 beacons. Accordingly in further embodiments, a non-beaconing device may be configured to shape its coverage area such that the coverage area does not extend outside the coverage area of a linked beaconing device. For example, the non-beaconing device may be configured to reduce its power transmission levels to reduce its coverage area so that it is contained within the coverage area of the beaconing device.

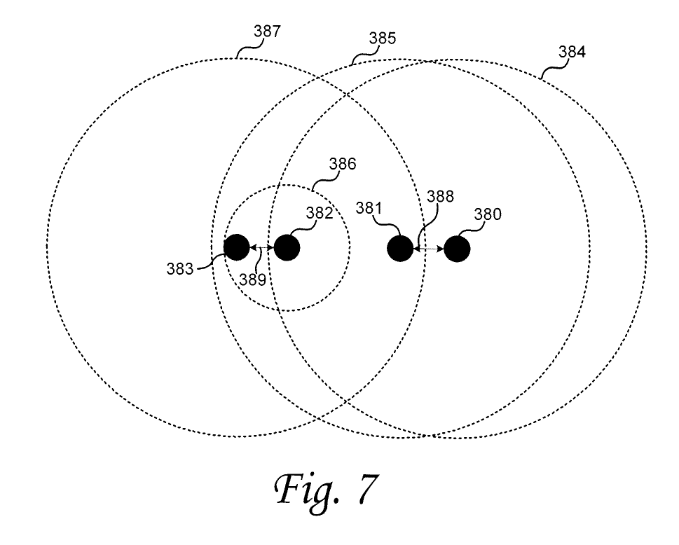

FIG. 7 illustrates an example network including beaconing and non-beaconing devices according to an embodiment of the invention. In this embodiment, beaconing devices 380, 381, and 383 transmit at similar power levels and transmission characteristics such that they have similar coverage ranges. Beaconing device 380 has a maximum range 384, beaconing device 381 has a maximum range 385, and beaconing device 383 has a maximum range 387. The network also includes a non-beaconing device 382 linked 389 to beaconing device 383 having a maximum range 386. As described herein, even though not beaconing device 382 is in the coverage range of both devices 381 and 380, non-beaconing device 382 may be close enough to its linked beaconing device 383 its signal-to-noise ratio still allows it to receive and decode information on link 389. Accordingly, non-beaconing device 382 may be configured not to monitor a beaconing period of a communications superframe. Furthermore, because non-beaconing device 382's coverage range is encompassed by beaconing device 383's coverage range, any devices that non-beaconing device 382 might interfere with our also within the coverage range of beaconing device 383. Accordingly, communications on link 389 will not interfere with other network communications because the communications on link 389 will be announced on the beacon period by device 383.

In some embodiments of the invention, device 382 may comprise a non-beaconing device that does not beacon its scheduled reception to device 381. For example, device 382 may be a device that is capable of entering beaconing modes and non-beaconing modes and may be configured to enter a non-beaconing mode at the request of a user of the device. In other embodiments, communications protocols may be provided that allow other network devices to cause the dual-mode device to switch between beaconing and non-beaconing modes. For example, a linked beaconing device may provide such a request as part of a private data communications management packet, such as the MMC packet described herein.

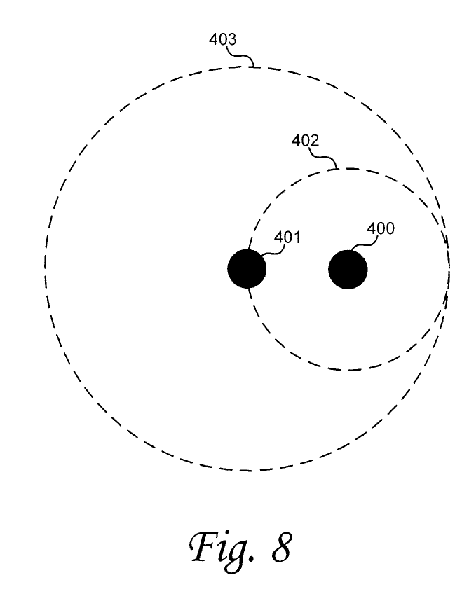

In various embodiments different methods may be used to configure a non-beaconing devices transmission characteristics so that it sufficiently likely that the non-beaconing device's coverage range will remain within a linked beaconing device's coverage range. FIG. 8 illustrates a case where a non-beaconing device 400's maximum range 402 is 50% of beaconing device 401's maximum range 403. Assuming a symmetric network link, whenever non-beaconing device 400 can establish a link with beaconing device 401, non-beaconing device 400's range 402 is encompassed by beaconing device 401's range 403. In actual network environments, transmission characteristics may vary between devices and may vary according to the various locations of the devices. In these environments, if the estimated transmission range of a non-beaconing device is configured to be only 50% that of the beaconing device, then it may be more likely that unpredictable changes to the coverage ranges of the devices can result in the non-beaconing device's range extending outside of the beaconing device's range. In such cases, it is possible that the non-beaconing device could interfere with a different network link between other network devices, where the other network devices would not be alerted by beaconing device 401. Accordingly, in some embodiments conservative estimations of a non-beaconing devices coverage range may be used so that it is sufficiently likely that the non-beaconing coverage range will remain within a beaconing coverage range during device operation. For example, a non-beaconing devices power may be set to 25% to 20% that a beaconing device to which it is linked. In these embodiments, typical or even atypical variations in coverage range due to physical location or other transmission characteristics will remain unlikely to cause a non-beaconing device's coverage range to extend outside of its linked beaconing device's coverage range.

In a particular embodiment, a network device implemented in accordance with embodiments of the invention may comprise a dual-mode network device. In a first network mode, a network device operates as a standard beaconing device and may transmit at standard power. In the second network mode, the network device may operate as a non-beaconing device and may reduce its transmitting power so that its coverage range is fully contained within a coverage range of a beaconing device with which it is in communication. This second network mode may allow the network device to save power by not processing, receiving, or transmitting beacons while maintaining normal data transfer rates with nearby network devices. In some embodiments, various methods may be used to determine which mode to transmitting. For example, a network device user may choose to enter the non-beaconing mode, for example, in order to save power. In another embodiment, a network device may operate solely as a non-beaconing network device. For example, a non-beaconing device may comprise a low range or low rate wireless network device, such as, for example, a mouse or keyboard connected to a PC, a cell phone headset, a synchronizing mobile phone, or a digital camera connected to a PC. Such devices may be typically used physically close to the devices with which they communicate. Accordingly, reducing the coverage range of these devices does not impact their use, yet allows them to communicate using lower power protocols and may free room for longer range or higher rate beaconing devices on a shared medium. In some embodiments, these non-beaconing devices may have large power savings over beaconing devices and even over devices that do not transmit, but still process beacons. In some environments, processing and monitoring a beaconing period, for example in a network having many beaconing devices, can require significant power consumption and computational resources. Accordingly, in addition to not having to spend power broadcasting a beacon, the non-beaconing device according to some embodiments can save power by not spending the power required for receipt and processing beacon transmissions. Additionally, and particularly for devices operating only in a non-beaconing mode, this further allows for a reduction in required circuit or computational complexity. Still further embodiments achieve additional power savings by requiring that non-beaconing devices in a network transmit at lower power levels than the beaconing devices in the network. Also, because some network elements are able to operate without beaconing periods, this may free space in the beaconing period that would otherwise be occupied. In some embodiments, this may result in power savings to beaconing devices as well because fewer beacons will be transmitted and fewer beacon slots will be needed as compared to a network having only beaconing devices.

In these embodiments, methods may be provided to allow information that would otherwise be transmitted during the beaconing periods to be transmitted to the non-beaconing devices within the device's private reservations. For example, one embodiment is configured to interact in wireless USB-based networks, such as wireless networks implemented according to the wireless universal serial bus specification revision 1.0, which is hereby incorporated by reference in its entirety. In this embodiment, the wireless universal serial bus micro-scheduled management control (MMC) packets may be modified to include distributed reservation protocol (DRP) information. In a particular embodiment, the MMC can include a tag (e.g., a certain bit set to “1”) to indicate support for non-beaconing devices. Once non-beaconing device B turns on, it can scan the channel for MMC packets. Upon receiving an MMC, the processing algorithm in non-beaconing devices may change to include extracting new information about DRP reservations from the MMC. The rest of the wireless universal serial bus protocol may be used without other changes, so the backwards compatibility with legacy devices is maintained.

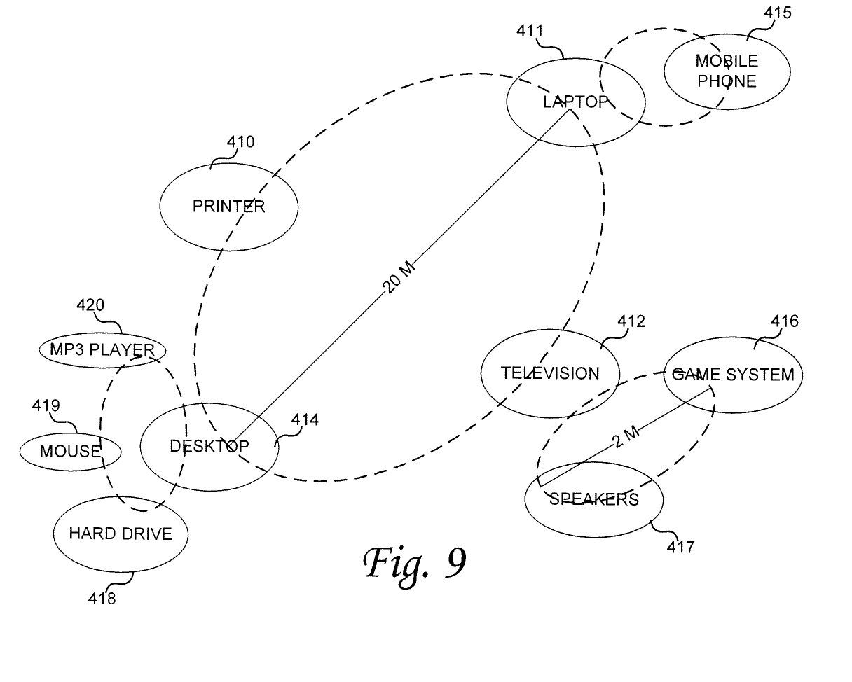

FIG. 9 illustrates a hybrid network architecture according to an embodiment of the invention. In this embodiment, a plurality of beaconing devices 411, 412, 414, and 410 and non-beaconing devices 415, 416, 417, 418, 419, and 420 belong to a network where communication activities on a shared medium are organized using superframes comprising timeslots. The superframes comprise beacon slots and data transmission slots, where the beacon slots are used by beaconing devices to reserve data transmission slots for transmission or reception. The non-beginning devices are configured such that their coverage ranges are encompassed by a linked beaconing device. For example, gaming system 416 and speakers 417 may be non-beaconing devices that are linked to television 412, which is a beaconing device. In the illustrated example, the non-beaconing devices may be configured such that their maximum transmission ranges are about 2 m, while the beaconing may be configured such that their maximum transmission ranges are about 20 m. Accordingly, the illustrated physical layout allows these devices to privately reserve transmission times with television 412. For example, because television 412 is aware of the beacons of desktop 414, printer 410, and laptop 411, television 412 can ensure that these private transmissions will not interfere with the rest of the network. Accordingly, in some embodiments beginning devices on the network may communicate using standard peer-to-peer protocols, while non-beaconing devices can coexist on the same medium and act as slaves to the beaconing devices.

In some further embodiments, a beaconing device having multiple connected non-beaconing devices may be configured to mediate communications between these non-beaconing devices. For example, a beaconing device, such as the desktop computer 414 in FIG. 9, might form links with, or be aware of, a plurality of non-beaconing devices, such as non-beaconing devices 420, 419, and 418. The non-beaconing devices may be capable of data transmission between each other, for example, mp3 player 420 may be capable of exchanging data with hard drive 418. However, because these devices do not beacon, the beaconing device 414 may be configured to mediate such communications. In some embodiments, beaconing device 414 may be configured to create a hierarchal type network with the beaconing devices, so that communications between the devices can occur between the beaconing devices. In other embodiments, the beaconing device may be configured to alert the non-beaconing devices 420 and 418 of each other's presence and may allow them to establish a link that beaconing device 414 may withdraw from. In such embodiments, these beaconing devices 414 may still monitor the transmissions, and may be configured to alert other network devices on the network during the beacon periods of these transmissions between non-beaconing devices.

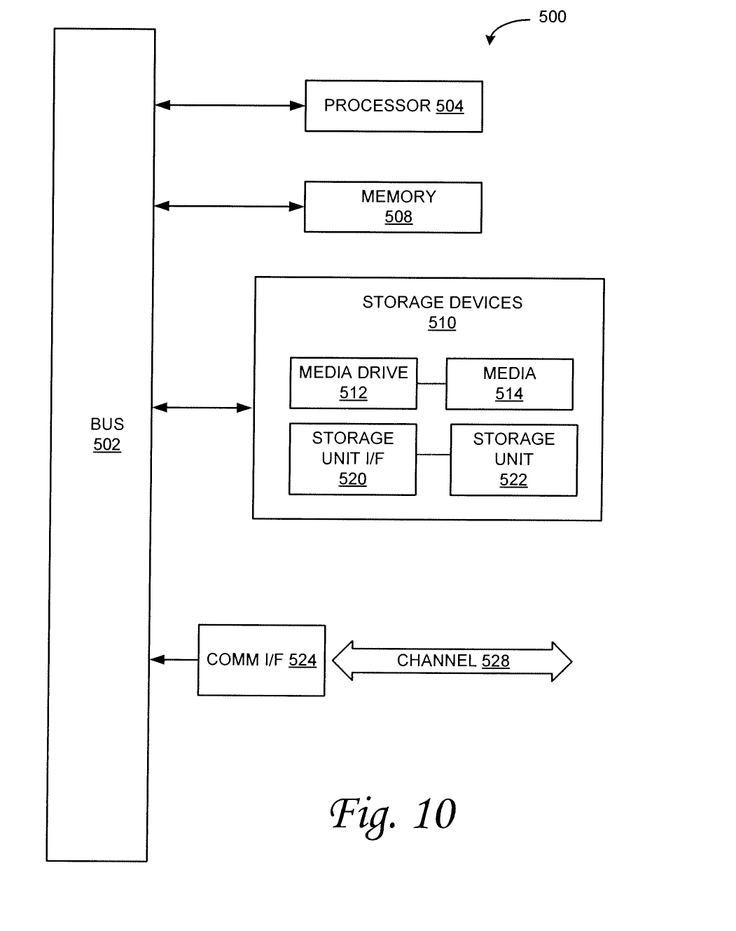

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 10. Various embodiments are described in terms of this example-computing module 500. After reading this description, it will become apparent to a person skilled in the relevant art how to implement the invention using other computing modules or architectures.

Referring now to FIG. 10, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Teens and phrases used in this document, and variations thereof, unless otherwise expressly stated, should be construed as open ended as opposed to limiting. As examples of the foregoing: the term “including” should be read as meaning “including, without limitation” or the like; the tem' “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of network operations, comprising:
conducting communication activities at a first network device using a shared network medium and having a first coverage area, wherein the communication activities comprise broadcasting a data transmission reservation or receiving a data transmission reservation of another network device during a beacon period; and
conducting communications with the first network device at a second network device using the shared network medium;
wherein the second network device is configured to provide a second coverage area that is substantially contained within the first coverage area and wherein the second network device does not monitor network communications during the beacon period.

2. The method of claim 2, wherein the second network device is further configured such that the second network device does not broadcast during the beacon period.

3. The method of claim 3, wherein the second network device is configured to transmit at a lower power level than the first network device such that the second coverage area is contained within the first coverage area.

4. The method of claim 3, wherein the second network device is further configured to exchange data transmission reservation information with the first network device during a data transmission period.

5. The method of claim 2, wherein the communication activities occur during superframes that are partitioned into timeslots, wherein a superframe comprises a beacon period comprising a first portion of timeslots and wherein the superframe comprises a data transfer period comprising a second portion of timeslots.

6. A network device configured to conduct communication activities with other network devices on a shared medium, comprising:
a computer readable medium having computer executable program code embodied thereon, wherein the computer executable program code is configured to cause the network device to perform the step of:
communicating with a beaconing network device in a non-beaconing mode, comprising:
establishing a communications link with the beaconing network device; and
not processing communications received from other network devices when those communications are received during a beacon period.

7. The network device of claim 6, wherein the step of communicating in a non-beaconing mode further comprises not broadcasting during the beacon period.

8. The network device of claim 7, wherein the step of communicating a non-beaconing mode further comprising transmitting at a power level configured to provide a first coverage area that is substantially within a second coverage area of the beaconing network device.

9. The network device of claim 8, wherein the computer executable program code is further configured to cause the network device to perform the step of communicating with a beaconing network device in a beaconing mode, comprising: receiving and processing external reservation requests of another network device during the beacon period and transmitting a reservation request for communications with the beaconing network device.

10. The network device of claim 9, wherein the computer executable program code is further configured to cause the network device to enter the non-beaconing mode if a request to enter the non-beaconing mode is received from the beaconing network device.

11. The network device of claim 9, wherein the computer executable program code is further configured to cause device to enter the non-beaconing mode according to input from a user of the network device.

12. The network device of claim 9, wherein the computer executable program code is further configured to cause the device to periodically enter the beaconing mode according to a predetermined period.

13. A network system, comprising:
a beaconing network device configured to conduct communication activities using a shared network medium and configured with a first coverage area, wherein the communication activities comprise broadcasting a data transmission reservation or receiving a data transmission reservation of another network device during a beacon period; and
a non-beaconing network device configured to communicate with the first network device without monitoring the beacon and further configured to have a second coverage area that is substantially contained within the first coverage area.

14. The network system of claim 13, wherein the second network device is further configured such that the second network device does not broadcast during the beacon period.

15. The network system of claim 14, wherein the second network device is configured to transmit at a lower power level than the first network device such that the second coverage area is contained within the first coverage area.

16. The network system of claim 15, wherein the first network device is configured to exchange data transmission reservation information with other network devices during the beacon period and wherein the second network device is further configured to exchange data transmission reservation information with the first network device during a data transmission period.

17. The network system of claim 14, wherein the second network device is further configured to enter a beaconing mode of operation wherein the second network device begins monitoring and broadcasting data transmission reservations on the beacon period.

18. The network system of claim 17, wherein the second network device is configured to enter the beaconing mode of operation according to input from a user of the second network device.

19. The network system of claim 17, wherein the second network devise is configured to periodically enter the beaconing mode of operation according to a predetermined period.

20. The network system of claim 17, wherein the second network device is configured to enter the beaconing mode of operation according to a request received from the first network device.
